(19) United States
(12) Patent Application Publication
(10) Pub. No.: US 2024/0311154 A1
(43) Pub. Date: Sep. 19, 2024

(54) Nested Loop Optimization with Vector Memory Instructions

(71) Applicant: SiFive, Inc., San Mateo, CA (US)

(72) Inventor: Nicholas Knight, Berkeley, CA (US)

(21) Appl. No.: 18/578,007

(22) PCT Filed: Jul. 12, 2022
(86) PCT No.: PCT/US2022/036777

§ 371 Date: Jan. 10, 2024

Related U.S. Application Data
(60) Provisional application No. 63/221,039, filed on Jul. 13, 2021.

(51) Int. Cl. G06F 9/30

(52) U.S. Cl. CPC G06F 9/30065

(57) ABSTRACT

A program sequence, comprising an inner loop nested in an outer loop, may be converted to multiple statements of the inner loop with a statement of the multiple statements changing by an index of the outer loop. A memory access for a first statement of the multiple statements may be combined with a memory access for a second statement of the multiple statements via a vector instruction (e.g., a segmented-strided vector instruction). The vector instruction may be configured to access sets of N data elements, where N is a segment size of data elements in consecutive locations in memory, and where sets of N data elements are spaced at a constant distance in memory.

### CROSS-REFERENCE TO RELATED APPLICATION(S)

This application claims priority to and the benefit of U.S. Provisional Patent Application Ser. No. 63/221,039, filed Jul. 13, 2021, the entire disclosure of which is hereby incorporated by reference.

### TECHNICAL FIELD

This disclosure relates to optimization of computer instructions, and in particular to nested loop structures.

### BACKGROUND

Nested loops may be utilized in implementations of computational algorithms such as a fast Fourier transform and matrix computations such as matrix multiplication and transposition. A nested loop is a loop within another loop to repeat one or more operations or instructions.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an integrated circuit supporting nested loop optimization with vector operations.

FIG. 2 is a block diagram of an example of an integrated circuit supporting nested loop optimization with vector operations.

FIG. 3 is a memory map of example vector memory instructions.

FIG. 4 is a flow chart of an example of a process for nested loop optimization with vector operations.

FIG. 5 is a flow chart of an example of a process for converting a program sequence and combining memory accesses.

FIG. 6 is a block diagram of an example of transposing a matrix using a vector instruction configured to store sets of N data elements.

FIG. 7 is a block diagram of an example of a vector instruction storing sets of N data elements to locations in memory.

FIG. 8 is a block diagram of an example of transposing a matrix using a vector instruction configured to load sets of N data elements.

FIG. 9 is a block diagram of an example of a vector instruction loading sets of N data elements from locations in memory.

FIG. 10 is a flow chart of an example of a process for executing a fast Fourier transform (FFT) computation.

FIG. 11 is a flow chart of an example of a process for combining statements of an inner loop to generate a combined statement and vectorizing the combined statement.

FIG. 12 is a flow chart of an example of a process for vectorizing statements of an inner loop to generate vector instructions and combining the vector instructions.

### DETAILED DESCRIPTION

An Instruction Set Architecture (ISA) (such as the RISC-V ISA) may implement vector memory access operations for loading and storing data elements in memory. For example, RISC-V vector memory access operations may include unit-stride memory accesses, constant-stride memory accesses (also known as “strided”), and indexed memory accesses (also known as “scatters and gathers”). A unit-stride memory access may be configured to access a block of data elements in consecutive locations in memory. A constant-stride memory access may be configured to access data elements in non-consecutive locations in memory with a constant distance (e.g., a fixed number of data elements) between the non-consecutive locations. For example, a constant-stride memory access may be configured to access data elements in non-consecutive locations with 1, 2, 4, or 8 data elements in between the non-consecutive locations. An indexed memory access may be configured to access data elements in locations offset from a fixed base address, such as according to a given list of offsets.

Generally, unit-stride memory accesses (e.g., accessing blocks of data elements in consecutive locations in memory) may be more efficient than constant-stride or indexed memory accesses. Implementations of computations involving fast Fourier transforms (FFTs) may involve numerous non-unit-stride memory accesses (e.g., constant-stride memory accesses and/or indexed memory accesses). Such implementations may be less efficient than computations utilizing unit-stride memory accesses, which may result in longer runtime, greater power consumption, or combinations thereof.

Implementations of this disclosure are designed to improve the efficiency of computations such as an FFT by executing a compiler to convert a program sequence, comprising an inner loop nested in an outer loop, to multiple statements of the inner loop (e.g., loop unrolling or unwinding). A statement of the multiple statements may change by an index of the outer loop. In some implementations, a first statement of the multiple statements may be fused with a second statement of the multiple statements so that the first statement and the second statement are part of a same loop (e.g., loop fusion or jamming). The compiler may combine a memory access for the first statement with a memory access for the second statement via a vector instruction. The vector instruction may be configured to access sets of N data elements in memory. N may be a segment size of data elements in consecutive locations in memory. Sets of N data elements may be spaced at a constant distance in memory. The vector instruction may access the sets of N data elements in memory to perform the memory access for the first statement and the memory access for the second statement. The memory accesses may comprise loads and/or stores between memory and a vector register. In some implementations, the vector instruction may be a segmented-strided vector instruction, and the segmented-strided vector instruction may combine a constant-stride memory access for the first statement with a constant-stride memory access for the second statement. In some implementations, the vector instruction may be used to transpose data elements arranged in a matrix, such as when executing an FFT (e.g., a Stockham FFT). Thus, the converting and the combining may reduce the costs of constant-stride memory accesses, such as when transposing data elements arranged in a matrix for an FFT.

Also described herein are systems and methods for nested loop optimization with vector operations. The techniques for nested loop optimization with vector operations may be used to realize one or more advantages over conventional processors. For example, the structures and techniques described herein may enable fast and efficient memory operations.

As used herein, the term “circuit” refers to an arrangement of electronic components (e.g., transistors, resistors, capacitors, and/or inductors) that is structured to implement one or more functions. For example, a circuit may include one or more transistors interconnected to form logic gates that collectively implement a logical function.

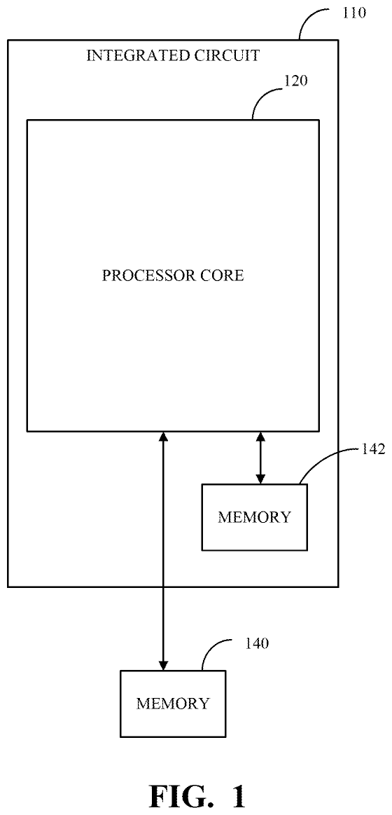

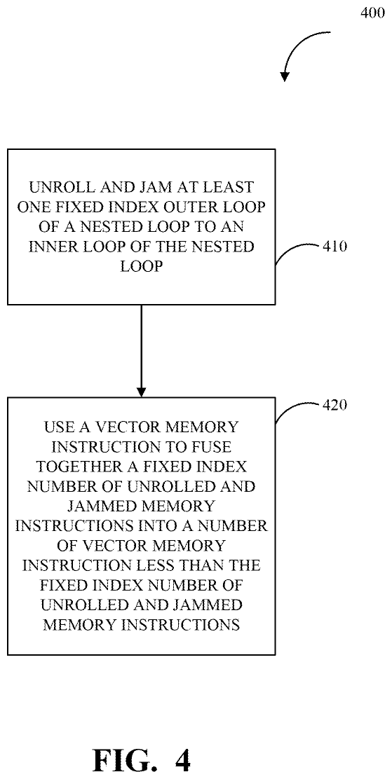

FIG. 1 is a block diagram of an example of an integrated circuit 110 for executing instructions using nested loop optimization with vector memory operations. The integrated circuit 110 includes a processor core 120. The processor core 120 is configured to fetch instructions from and access data stored in a memory 140 external to the integrated circuit 110 and/or a memory 142 internal to the integrated circuit 110. The integrated circuit 110 may provide advantages over conventional processor architectures, such as, for example, enabling fast and efficient vector memory operations. For example, the integrated circuit 110 may implement the process 400 of FIG. 4.

The integrated circuit 110 includes a processor core 120, which may include a pipeline configured to execute instructions, including unit-stride and constant-stride vector memory instructions. The pipeline stages can include for example, fetch, decode, rename, dispatch, issue, execute, memory access, and write-back stages. For example, the processor core 120 may be configured to execute instructions of a RISC V instruction set which includes a RISC-V vector extension instruction set.

The processor core 120 may be configured to fetch instructions from a memory 140 external to the integrated circuit 110 that stores instructions and/or data. The processor core 120 may be configured to access data in the memory 140 in response to instructions, including vector memory instructions (e.g., the vector load instruction 310 or the vector store instruction 330). For example, the processor core 120 may access data in the memory directly or via one or more caches. The processor core 120 may also be configured to fetch instructions from a memory 142 internal to the integrated circuit 110 that stores instructions and/or data. The processor core 120 may be configured to access data in the memory 142 in response to instructions, including vector memory instructions. Although not shown in FIG. 1, the integrated circuit 110 may include multiple processor cores in some implementations.

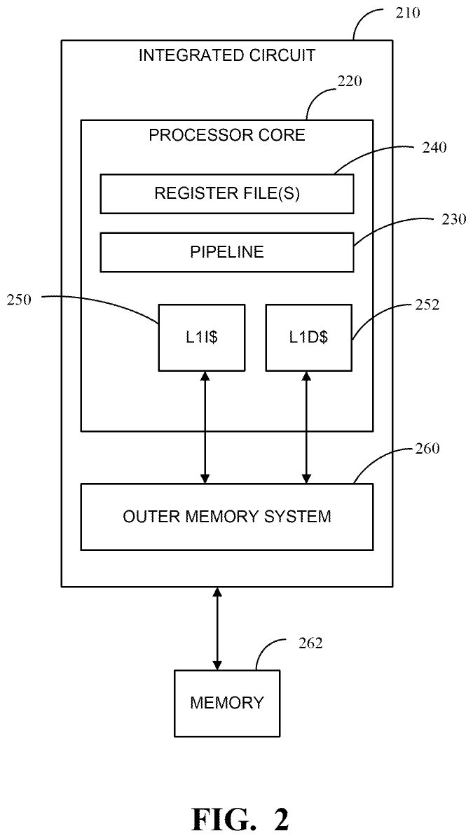

FIG. 2 is a block diagram of an example of an integrated circuit 210 for executing instructions using nested loop optimization with vector memory operations. The integrated circuit 210 includes a processor core 220. The processor core 220 includes one or more register files 240, which may include vector registers. The processor core 220 includes an L1 instruction cache 250 and an L1 data cache 252. The integrated circuit 210 includes an outer memory system 260, which may include memory storing instructions and data and/or provide access to a memory 262 external to the integrated circuit 210 that stores instructions and/or data. The integrated circuit 210 may provide advantages over conventional processor architectures, such as, for example, enabling fast and efficient vector memory operations for nested loop optimization. For example, the integrated circuit 210 may implement the process 400 of FIG. 4.

The integrated circuit 210 includes a processor core 220 including a pipeline 230 configured to execute instructions, including unit-stride and constant-stride vector memory instructions. The pipeline 230 includes one or more fetch stages that are configured to retrieve instructions from a memory system of the integrated circuit 210. For example, the pipeline 230 may fetch instructions via the L1 instruction cache 250. The pipeline 230 may include additional stages, such as decode, rename, dispatch, issue, execute, memory access, and write-back stages. For example, the processor core 220 may include a pipeline 230 configured to execute instructions of a RISC-V instruction set which includes a RISC-V vector extension instruction set.

The integrated circuit 210 includes one or more register files 240 for the processor core 220. The one or more register files 240 may store part or all or an architectural state of the processor core 220. For example, the one or more register files 240 may include a set of vector registers. For example, the one or more register files 240 may include a set of control and status registers (CSRs). For example, the one or more register files 240 may include a set of scalar registers.

The integrated circuit 210 includes an L1 instruction cache 250 for the processor core 220. The L1 instruction cache 250 may be a set-associative cache for instruction memory. To avoid the long latency of reading a tag array and a data array in series, and the high power of reading the arrays in parallel, a way predictor may be used. The way predictor may be accessed in an early fetch stage and the hit way may be encoded into the read index of the data array. The tag array may be accessed in a later fetch stage and may be used for verifying the way predictor.

The integrated circuit 210 includes an L1 data cache 252 for the processor core 220. For example, the L1 data cache 252 may be a set-associative VIPT cache, meaning that it is indexed purely with virtual address bits and tagged fully with all translated physical address bits. For low power consumption, the tag and data arrays may be looked up in serial so that at most a single data SRAM way is accessed. For example, the line size of the L1 data cache 252 may be 64 Bytes, and the beat size may be 26 Bytes.

The integrated circuit 210 includes an outer memory system 260, which may include memory storing instructions and data and/or provide access to a memory 262 external to the integrated circuit 210 that stores instructions and/or data. For example, the outer memory system 260 may include an L2 cache, which may be configured to implement a cache coherency protocol/policy to maintain cache coherency across multiple L1 caches. Although not shown in FIG. 2, the integrated circuit 210 may include multiple processor cores in some implementations. For example, the outer memory system 260 may include multiple layers.

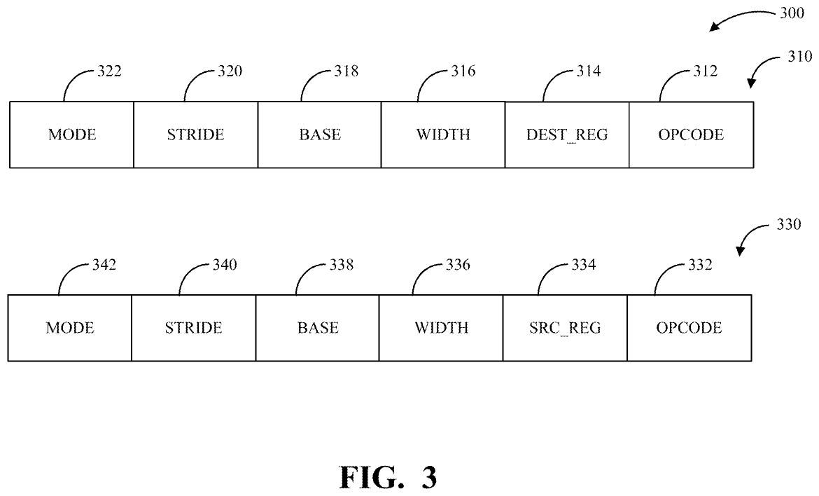

FIG. 3 is a memory map of an example vector memory instructions 300 that includes a vector load instruction 310 and a vector store instruction 330. The vector load instruction 310 includes an opcode 312, a destination register field 314 that identifies an architectural register to be used to store a result of the vector load instruction 310, a width field 316 that specifies the size of memory elements of a vector being loaded from memory, a base register field 318 that identifies an architectural register that stores a base address for the vector in memory, a stride register field 320 that identifies an architectural register that stores a stride (e.g., one for a unit-stride vector load or another constant stride) for the vector in memory, and a mode field 322 that specifies additional or optional parameters (e.g., including a memory addressing mode and/or a number of fields in each segment) for the vector load instruction 310. The vector store instruction 330 includes an opcode 332, a source register field 334 that identifies an architectural register holding vector data for storage, a width field 336 that specifies the size of memory elements of a vector being stored in memory, a base register field 338 that identifies an architectural register that stores a base address for the vector in memory, a stride register field 340 that identifies an architectural register that stores a stride for the vector in memory, and a mode field 342 that specifies additional or optional parameters (e.g., including a memory addressing mode and/or a number of fields in each segment) for the vector store instruction 330. For example, in a RISC-V processor core, the vector load instruction 310 may use the LOAD-FP major opcode with a vector encoding extension and the vector store instruction 330 may use the STORE-FP major opcode with a vector encoding extension.

FIG. 4 is a flow chart of an example of a process 400 for nested loop optimization with vector memory operations. The process 400 includes unrolling and jamming 410 at least one fixed index outer loop of a nested loop to an inner loop of the nested loop; and using 420 a vector memory instruction to fuse together a fixed index number of unrolled and jammed memory instructions into a number of vector memory instructions less than the fixed index number of unrolled and jammed memory instructions. For example, the process 400 may be implemented using the integrated circuit 110 of FIG. 1. For example, the process 400 may be implemented using the integrated circuit 210 of FIG. 2.

The process 400 includes unrolling and jamming 410 at least one fixed index outer loop of a nested loop to an inner loop of the nested loop. A nested loop can include multiple loops nested together where each outer loop relative to an inner loop has a fixed index as to how many times the inner loop is executed. In some implementations, the inner loop includes a memory instruction such as a load or a store. In some implementations, the inner loop includes a memory instruction such as a strided load or a strided store which is offset using the fixed index. An unroll-and-jam technique can be applied to the outer loop where an inner loop is replicated a fixed index number of times. Each replicated portion references a different element of an array based on the fixed index resulting in a fixed index number of array elements which need to be fetched.

The process 400 includes using 420 a vector memory instruction to fuse together a fixed index number of unrolled and jammed memory instructions into a number of vector memory instructions less than the fixed index number of unrolled and jammed memory instructions. The unit-stride and constant-stride vector memory instructions can be used to fuse or combine the fixed index number of unrolled and jammed memory instructions into a number of unit-stride and constant-stride vector memory instructions which are less than the fixed index number of unrolled and jammed memory instructions. This can increase speed and efficiency with respect to computation and memory resources. For example, the strided loads/stores can be fused into a smaller number of loads/stores of pairs/triplets/etc. of array elements.

The process 400 can be used to implement more efficient fast Fourier transform (FFT) computations. For FFTs, the process 400 can reduce the cost of strided accesses in Stockham's algorithm with middle-loop vectorization. Stockham's FFT algorithm with inner-loop vectorization features all unit-stride accesses, but suffers shorter application vectors as the computation proceeds. Swarztrauber's variant switches, at an intermediate stage, to middle-loop vectorization to maintain high vector utilization, but sacrifices the unit-stride access pattern subsequently: process 400 can be applied here. The process 400 can be used similarly to optimize any of the well-known FFT factorizations such as Cooley-Tukey, Pease, transposed Stockham, and others.

In some implementations, the process 400 can be applied to a hybrid Stockham-Swarztrauber FFT, where, when switching from inner-loop to middle-loop vectorization, simultaneous transposition of the data array and switching to the “transpose Stockham” algorithm occurs. The transposition is fused into the adjacent stages, so that there is only a single strided load (or store) of the data array. Stride segment fusion (process 400) can then be applied.

In some implementations, Bailey's long weight vector optimization can also be applied to ensure twiddle-factor loads are purely unit-stride.

Some implementations may include a method comprising unrolling and jamming at least one outer loop of a nested loop to an inner loop of the nested loop, wherein each outer loop has a fixed index; and using a vector memory instruction to fuse together a fixed index number of unrolled and jammed memory instructions into a number of vector memory instructions less than the fixed index number of unrolled and jammed memory instructions. Some implementations may include a computer-implemented method for nested loop optimization, the method comprising: unrolling and jamming at least one outer loop of a nested loop to an inner loop of the nested loop, wherein each outer loop has a fixed index; and using a vector memory instruction to fuse together a fixed index number of unrolled and jammed memory instructions into a number of vector memory instructions less than the fixed index number of unrolled and jammed memory instructions. Some implementations may include a computer readable media storing data and instructions, said data and instructions, when executed, adapting a computer system to optimize nested loop operation using vector memory instructions, said computer system adapted to: unroll and jam at least one outer loop of a nested loop to an inner loop of the nested loop, wherein each outer loop has a fixed index; and use a vector memory instruction to fuse together a fixed index number of unrolled and jammed memory instructions into a number of vector memory instructions less than the fixed index number of unrolled and jammed memory instructions.

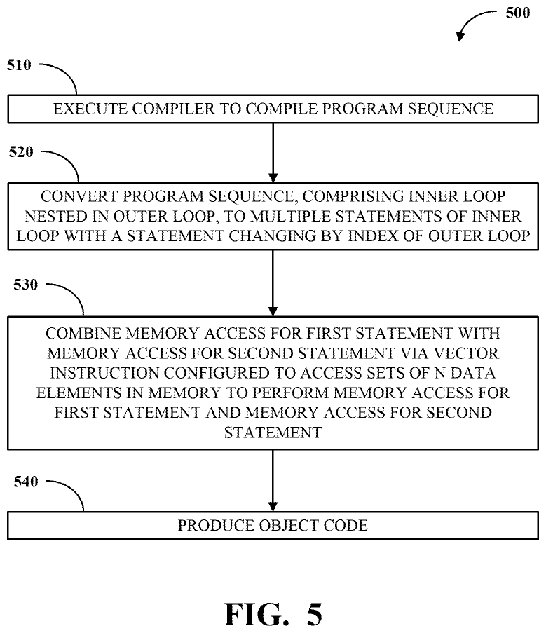

FIG. 5 is a flow chart of an example of a process 500 for converting a program sequence and combining memory accesses. For example, the process 500 may be implemented using the integrated circuit 110 of FIG. 1 or the integrated circuit 210 of FIG. 2. The process 500 may include executing 510 a compiler to compile a program sequence. For example, the compiler may execute to translate the program sequence from source code to object code. The program sequence may comprise an inner loop nested in an outer loop. For example, to transpose data elements of a first N×N matrix (e.g., Matrix A) to a second N×N matrix (e.g., Matrix B), a program sequence could include:

```
For I = 0:N−1
  For J=0:N−1
    B[J*N + I]=A[I*N+J]
```

Where “For I=0:N−1” is an outer loop: where “For J=0:N−1,” and “B[J*N+I]=A[I*N+J],” is an inner loop that is nested in the outer loop: where “A” is associated with the first matrix (with rows indexed by “I” and columns by “J”); and where “B” is associated with the second matrix (with rows indexed by “J” and columns by “I”).

The process 500 may also include converting 520 the program sequence, comprising the inner loop nested in the outer loop, to multiple statements of the inner loop. For example, converting the program sequence may comprise unrolling the outer loop (e.g., loop unrolling or unwinding). After unrolling, a statement of the multiple statements may change by an index of the outer loop. For example, the above program sequence could be unrolled to include multiple statements of the inner loop, such as:

```
For I = 0:2:N−1
  For J=0:N−1
    B[J*N + I]=A[I*N+J]
  For J=0:N−1
    B[J*N + I + 1]=A[(I + 1)*N + J]
```

Where “2” is the stride: where “For J=0:N−1” (followed by “B[J*N+I]=A[I*N+J]”) is a first statement of the inner loop: where “For J=0:N−1” (followed by “B[J*N+I+1]=A[(I+1)*N+J]”) is a second statement of the inner loop, and where the statements change by an index of the outer loop (e.g., the outer loop index “I”).

The process 500 may also include combining 530 a memory access for a first statement with a memory access for a second statement via a vector instruction (e.g., the combining may be referred to as a stride segment fusion). For example, the compiler may execute to combine the memory access for the first statement with the memory access for the second statement via a vector instruction. The vector instruction may be configured to access sets of N data elements in memory. N may be a segment size of data elements in consecutive locations in memory. Sets of N data elements may be spaced at a constant distance in memory. The vector instruction may be configured to access the sets of N data elements in memory to perform the memory access for the first statement and the memory access for the second statement. For example, the memory accesses may comprise loads and/or stores between memory and a vector register. The vector instruction may be a segmented-strided vector instruction. The segmented-strided vector instruction may combine a constant-stride memory access for the first statement with a constant-stride memory access for the second statement. Thus, stride segment fusion (e.g., via a segmented-strided vector instruction) may permit obtaining long application vector lengths while mitigating the cost of strided memory accesses. The segmented-strided vector instruction may be more efficient than constant-stride memory accesses (e.g., “strided”), and may be more efficient than index memory accesses (e.g., “scatters and gathers”). In some implementations, the vector instruction may be used to transpose data elements arranged in a matrix, such as when executing an FFT (e.g., a Stockham FFT). In some implementations, the vector instruction may be used for matrix-multiplication operations, such as for a neural network application.

In one example, when transposing data elements of the first N×N matrix (e.g., Matrix A) to the second N×N matrix (e.g., Matrix B), after unrolling, the first statement of the inner loop “For J=0:N−1” (and “B[J*N+I]=A[I*N+J]”) may be combined with the second statement of the inner loop “For J=0:N−1” (and “B[J*N+I+1]=A[(I+1)*N+J]”) to generate a combined statement (e.g., loop fusion or jamming), such as:

```
For I = 0:2:N−1
  For J=0:N−1
    B[J*N + I]=A[I*N+J]
    B[J*N + I + 1]=A[(I + 1)*N + J]
```

Where “For J=0:N−1” (and “B[J*N+I]=A[I*N+J],” and “B[J*N+I+1]=A[(I+1)*N+J]”) is the combined statement of the inner loop. The combined statement may be vectorized via a vector instruction configured to access sets of N data elements in memory to perform memory accesses for the combined statement (e.g., via a segmented-strided vector instruction). For example, the vectorized program sequence may be:

```
For I = 0:2:N−1
  For J=0:vL:N−1
    unit-stride vector instruction 1 (load)
    unit-stride vector instruction 2 (load)
    segmented-strided vector instruction (segmented store)
```

Where “vL” is the vector length: where “unit-stride vector instruction 1” may be a first memory access, such as to load data elements in a first row of the matrix A (from memory to a vector register); where “unit-stride vector instruction 2” may be a second memory access, such as to load data elements in a second row of the matrix A (from memory to the vector register); and where “segmented-strided vector instruction” may be a vector instruction combining a first memory access with a second memory access, such as to store data elements in memory (from the vector register to memory).

In another example, when transposing data elements of the first N×N matrix (e.g., Matrix A), to the second N×N matrix (e.g., Matrix B), the first statement of the inner loop “For J=0:N−1” (and “B[J*N+I]=A[I*N+J]”) may be vectorized via a first set of vector instructions, and the second statement of the inner loop “For J=0:N−1” (and “B[J*N+I+1]=A[(I+1)*N+J]”) may be vectorized via a second set of vector instructions, such as:

```
For I = 0:2:N−1
  For J=0:vL:N−1
    unit-stride vector instruction 1 (load)
    unit-stride vector instruction 2 (load)
    constant-stride vector instruction 3 (store)
    constant-stride vector instruction 4 (store)
```

Where “vL” is the vector length: where “unit-stride vector instruction 1” may be a first memory access, such as to load data elements in a first row of the matrix A (from memory to a vector register); where “unit-stride vector instruction 2” may be a second memory access, such as to load data elements in a second row of the matrix A (from memory to the vector register); where “constant-stride vector instruction 3” may be a third memory access, such as to store data elements in a first column of the matrix B (from the vector register to memory); and where “constant-stride vector instruction 4” may be a fourth memory access, such as to store data elements in a second column of the matrix B (from the vector register to memory). The third memory access and the fourth memory access may be combined via a single vector instruction (e.g., a segmented-strided vector instruction), such as:

```
For I = 0:2:N−1
  For J=0:vL:N−1
    unit-stride vector instruction 1 (load)
    unit-stride vector instruction 2 (load)
    segmented-strided vector instruction (segmented store)
```

The process 500 may also include producing 540 object code (e.g., compiled code) implementing the vector instruction (e.g., the segmented-strided vector instruction). For example, executing the compiler may cause the compiler to compile the program sequence, including with the converting 520 and the combining 530, to produce the object code. The object code may be executed by an integrated circuit (e.g., the integrated circuit 110 or the integrated circuit 210), such as when executing an FFT computation or when executing a matrix-multiplication operation. The converting 520 and the combining 530 may reduce constant-stride memory accesses when executed by the integrated circuit, such as by producing compiled code that permits more efficiently transposing data elements arranged in a matrix for executing the FFT computation or the matrix-multiplication operation.

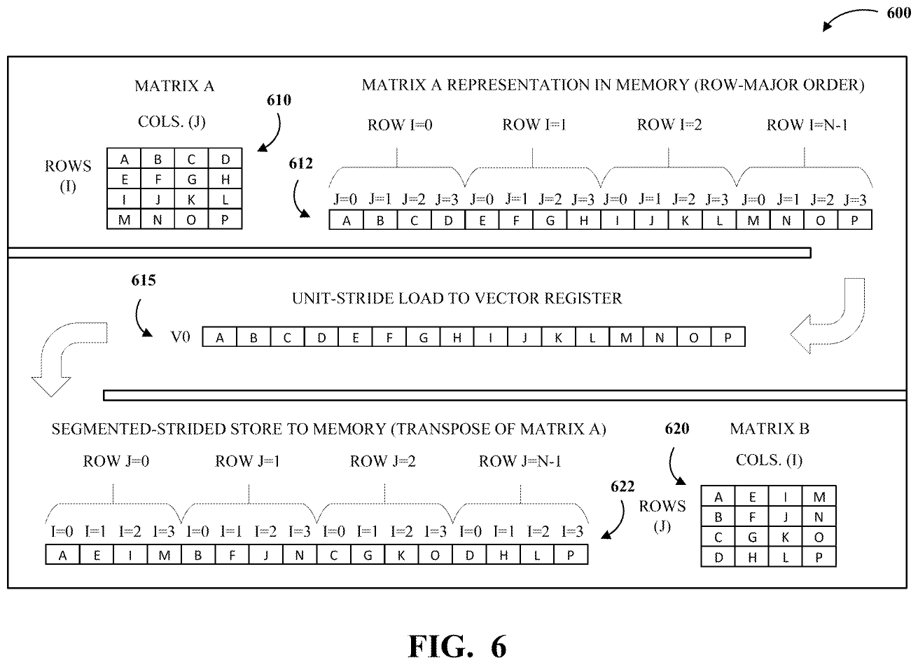

FIG. 6 is a block diagram of an example 600 of transposing a matrix 610 (e.g., “Matrix A”) using a vector instruction configured to store sets of N data elements. Data elements arranged in the matrix 610 may be transposed to produce data elements arranged in a matrix 620 (e.g., “Matrix B”). For example, the integrated circuit 110 of FIG. 1, or the integrated circuit 210 of FIG. 2, may execute a program sequence to transpose a matrix as shown in the example 600. For example, one or more steps of the process 500 may be used to transpose a matrix as shown in the example 600.

The matrix 610 may be a multidimensional array, such as a 4×4 matrix with sixteen data elements (e.g., data elements A to P) arranged in four rows (I) and four columns (J). The data elements of the matrix 610 may be stored in linear locations in memory 612, such as in row-major order (e.g., the consecutive data elements of a row are stored in consecutive locations in memory, adjacent to one another). For example, data elements A, B, C, and D, arranged in the first row of the matrix 610 (e.g., I=0), may be stored in a first group of four consecutive locations in memory 612: data elements E, F, G, and H, arranged in the second row of the matrix 610 (e.g., I=1), may be stored in a second group of four consecutive locations in memory 612 (e.g., adjacent to the first group of four consecutive locations); data elements I, J, K, and L, arranged in the third row of the matrix 610 (e.g., I=2), may be stored in a third group of four consecutive locations in memory 612 (e.g., adjacent to the second group of four consecutive locations); and data elements M, N, O, and P, arranged in the fourth row of the matrix 610 (e.g., I=3), may be stored in a fourth group of four consecutive locations in memory 612 (e.g., adjacent to the third group of four consecutive locations). Thus, the data elements in the memory 612 may be stored in a first ordered arrangement associated with the matrix 610.

It may be desirable to transpose data elements arranged in the matrix 610 to the matrix 620, such as when executing an FFT computation or a matrix-multiplication operation as part of a program sequence. The matrix 620 may be a multidimensional array, such as a 4×4 matrix with sixteen data elements (e.g., data elements A to P), like the matrix 610. However, the data elements in the matrix 620 may be transposed with the data elements arranged in rows (J) and columns (I). For example, in the matrix 620, data elements A, B, C, and D may be arranged in the first column (e.g., I=0): data elements E, F, G, and H, may be arranged in the second column (e.g., I=1); data elements I, J, K, and L may be arranged in the third column (e.g., I=2); and data elements M, N, O, and P may be arranged in the fourth column (e.g., I=3). The data elements of the matrix 620 may be stored in linear locations in memory 622, also in row-major order. Thus, the data elements in the memory 622 may be stored in a second ordered arrangement associated with the matrix 620, which is transposed from the first ordered arrangement associated with the matrix 610. In some implementations, the memory 612 may be the same as the memory 622. In some cases, the data elements associated with the matrix 620 may overwrite the data elements associated with the matrix 610 in the memory 612. In some implementations, the memory 612 may be a first memory and the memory 622 may be a second memory.

Implementations of this disclosure address problems such as these by implementing a vector instruction, such as a segmented-strided vector instruction. One or more unit-stride memory accesses (e.g., one or more unit-stride load vector instructions) may execute to load data elements, stored consecutively in linear locations in the memory 612, to a vector register 615 (e.g., “V0”). For example, a first unit-stride memory access may load data elements A, B, C, and D, stored in the first group of four consecutive locations in memory 612, to a first group of four consecutive locations in the vector register 615. A second unit-stride memory access may load data elements E, F, G, and H, stored in the second group of four consecutive locations in memory 612, to a second group of four consecutive locations in the vector register 615 (e.g., adjacent to the first group of four consecutive locations in the vector register 615). A third unit-stride memory access may load data elements I, J, K, and L, stored in the third group of four consecutive locations in memory 612, to a third group of four consecutive locations in the vector register 615 (e.g., adjacent to the second group of four consecutive locations in the vector register 615). A fourth unit-stride memory access may load data elements M, N, O, and P, stored in a fourth group of four consecutive locations in memory 612, to a fourth group of four consecutive locations in the vector register 615 (e.g., adjacent to the third group of four consecutive locations in the vector register 615).

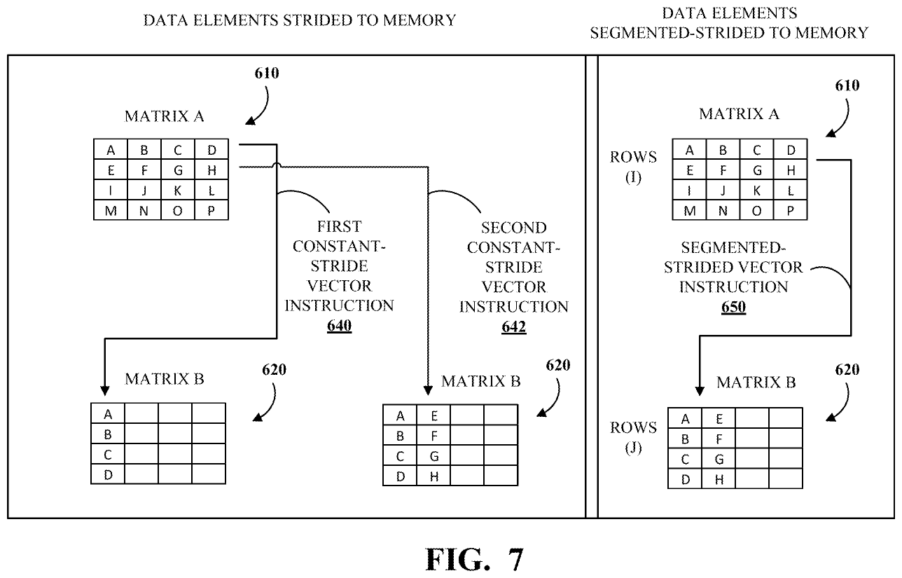

A first segmented-strided vector instruction may execute to store sets of N data elements in the memory 622, from the vector register 615. N may be a segment size of data elements in consecutive locations in memory, such as N=2 in the example 600 (e.g., a seg2 vector instruction). Sets of N data elements may be spaced at a constant distance in memory, such as D=2 in the example 600. For example, a first segmented-strided vector instruction may execute to store four sets of two data elements (e.g., set one including A and E, set two including B and F, set three including C and G, and set four including D and H) in the memory 622, from the vector register 615. Thus, the first segmented-strided vector instruction may combine in one, more efficient instruction what might have been done by a first constant-stride memory access (e.g., to store data elements A, B, C, and D non-consecutively in the memory 622, spaced with four data elements in between, or a stride of four) and a second constant-stride memory access (e.g., to store data elements E, F, G, and H non-consecutively in the memory 622 with four data elements in between, or a stride of four). For example, with additional reference to FIG. 7, a segmented-strided vector instruction 650 (e.g., the first segmented-strided vector instruction) may combine in one, more efficient instruction what might have been done by a first constant-stride vector instruction 640 (e.g., to store data elements A, B, C, and D, non-consecutively in the memory 622, for the matrix 620) followed by a second constant-stride vector instruction 642 (e.g., to store data elements E, F, G, and H, non-consecutively in the memory 622, for the matrix 620).

Referring again to FIG. 6, a second segmented-strided vector instruction, configured similarly to the first segmented-strided vector instruction, may execute to store another four sets of two data elements (e.g., set one including I and M, set two including J and N, set three including K and O, and set four including L and P) in the memory 622, from the vector register 615. The second segmented-strided vector instruction may also combine in one, more efficient instruction what might have been done by a third constant-stride memory access (e.g., to store data elements I, J, K, and L non-consecutively in the memory 622, spaced with four data elements in between, or a stride of four) and a fourth constant-stride memory access (e.g., to store data elements M, N, O, and P non-consecutively in the memory 622, spaced with four data elements in between, or a stride of four). Further, the second segmented-strided vector instruction may complete the transposition of the matrix 610, to generate the matrix 620, with fewer memory accesses than had constant-stride memory accesses been used.

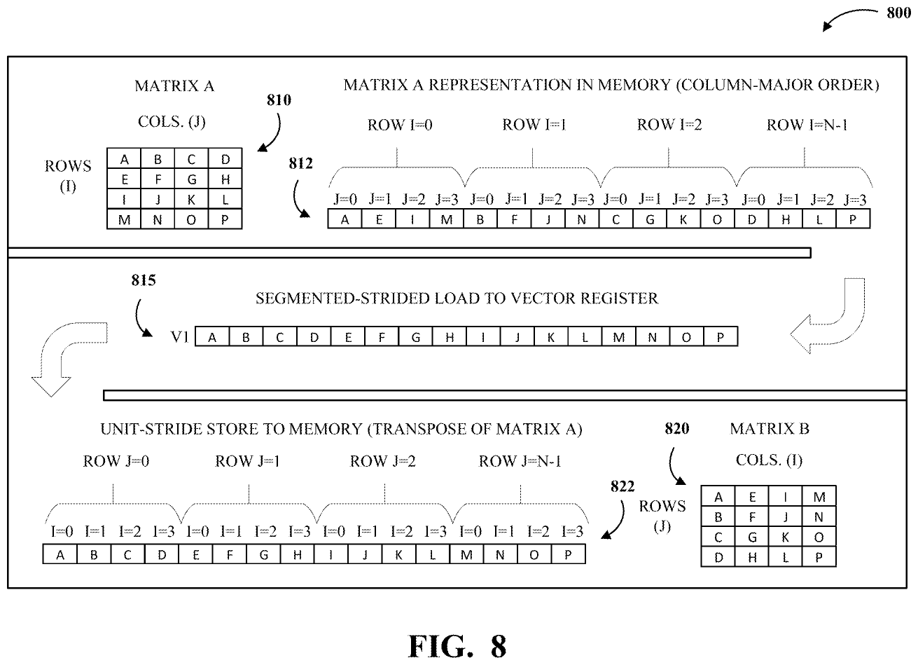

FIG. 8 is a block diagram of an example 800 of transposing a matrix 810 (e.g., “Matrix A”) using a vector instruction configured to load sets of N data elements. Data elements arranged in the matrix 810 may be transposed to produce data elements arranged in a matrix 820 (e.g., “Matrix B”). For example, the integrated circuit 110 of FIG. 1, or the integrated circuit 210 of FIG. 2, may execute a program sequence to transpose a matrix as shown in the example 800. For example, one or more steps of the process 500 may be used to transpose a matrix as shown in the example 800.

The matrix 810 may be a multidimensional array, such as a 4×4 matrix with sixteen data elements (e.g., data elements A to P) arranged in four rows (I) and four columns (J). The data elements of the matrix 810 may be stored in linear locations in memory 812, such as in column-major order (e.g., the consecutive data elements of a column are stored in consecutive locations in memory, adjacent to one another). For example, data elements A, E, I, and M, arranged in the first column of the matrix 810 (e.g., J=0), may be stored in a first group of four consecutive locations in memory 812: data elements B, F, J, and N, arranged in the second column of the matrix 810 (e.g., J=1), may be stored in a second group of four consecutive locations in memory 812 (e.g., adjacent to the first group of four consecutive locations): data elements C, G, K, and O, arranged in the third column of the matrix 810 (e.g., J=2), may be stored in a third group of four consecutive locations in memory 812 (e.g., adjacent to the second group of four consecutive locations); and data elements D, H, L, and P, arranged in the fourth column of the matrix 810 (e.g., J=3), may be stored in a fourth group of four consecutive locations in memory 812 (e.g., adjacent to the third group of four consecutive locations). Thus, the data elements in the memory 812 may be stored in a first ordered arrangement associated with the matrix 810.

It may be desirable to transpose data elements arranged in the matrix 810 to the matrix 820, such as when executing an FFT computation or a matrix-multiplication operation as part of a program sequence. The matrix 820 may be a multidimensional array, such as a 4×4 matrix with sixteen data elements (e.g., data elements A to P), like the matrix 810. However, the data elements in the matrix 820 may be transposed, so that the data elements are arranged in rows (J) and columns (I). For example, in the matrix 820, data elements A, B, C, and D may be arranged in the first column (e.g., I=0): data elements E, F, G, and H, may be arranged in the second column (e.g., I=1); data elements I, J, K, and L may be arranged in the third column (e.g., I=2); and data elements M, N, O, and P may be arranged in the fourth column (e.g., I=3). The data elements of the matrix 820 may be stored in linear locations in memory 822, also in column-major order. Thus, it may be desirable to store the data elements in the memory 822 in a second ordered arrangement associated with the matrix 820, which is transposed from the first ordered arrangement associated with the matrix 810. In some cases, the data elements associated with the matrix 820 may overwrite the data elements associated with the matrix 810 in the memory 812. In some implementations, the memory 812 may be a first memory and the memory 822 may be a second memory.

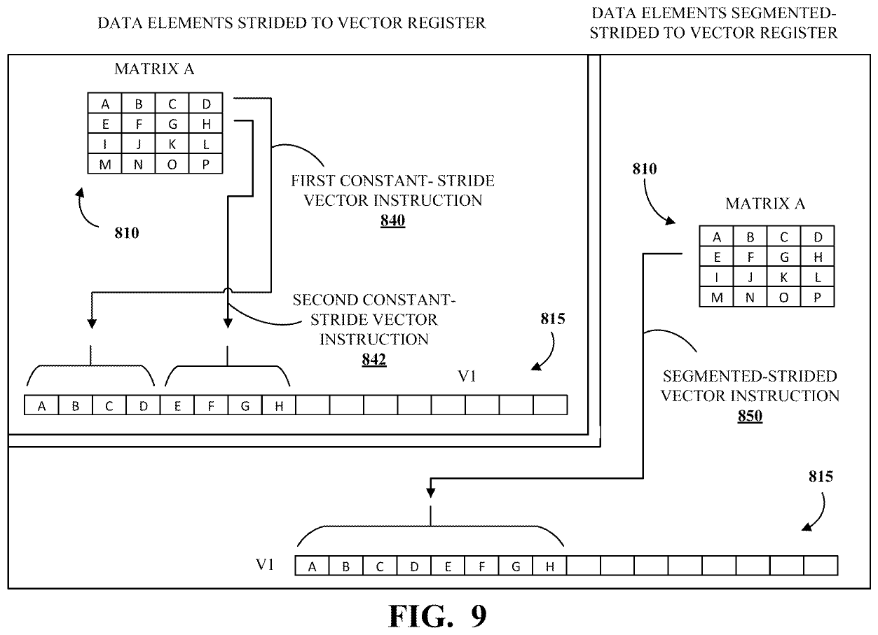

Implementations of this disclosure address problems such as these by implementing a vector instruction, such as a segmented-strided vector instruction. A first segmented-strided vector instruction may execute to load sets of N data elements, from the memory 812, to the vector register 815. N may be a segment size of data elements in consecutive locations in memory, such as N=2 in the example 800 (e.g., a seg2 vector instruction). Sets of N data elements may be spaced at a constant distance in memory, such as D=2 in the example 800. For example, a first segmented-strided vector instruction may execute to load four sets of two data elements (e.g., set one including A and E, set two including B and F, set three including C and G, and set four including D and H) from the memory 812, to the vector register 815. Thus, the first segmented-strided vector instruction may combine in one, more efficient instruction what might have been done by a first constant-stride memory access (e.g., to load data elements A, B, C, and D non-consecutively from the memory 812, spaced with four data elements in between, or a stride of four) and a second constant-stride memory access (e.g., to load data elements E, F, G, and H non-consecutively from the memory 812, spaced with four data elements in between, or a stride of four). For example, with additional reference to FIG. 9, a segmented-strided vector instruction 850 (e.g., the first segmented-strided vector instruction) may combine in one, more efficient instruction what might have been done by a first constant-stride vector instruction 840 (e.g., to load data elements A, B, C, and D, non-consecutively from the memory 812, to the vector register 815) followed by a second constant-stride vector instruction 842 (e.g., to load data elements E, F, G, and H, non-consecutively from the memory 812, to the vector register 815).

Referring again to FIG. 8, a second segmented-strided vector instruction, configured similarly to the first segmented-strided vector instruction, may execute to load another four sets of two data elements (e.g., set one including I and M, set two including J and N, set three including K and O, and set four including L and P) from the memory 812, to the vector register 815. The second segmented-strided vector instruction may also combine in one, more efficient instruction what might have been done by a third constant-stride memory access (e.g., to load data elements I, J, K, and L non-consecutively from the memory 812, spaced with four data elements in between, or a stride of four) and a fourth constant-stride memory access (e.g., to load data elements M, N, O, and P non-consecutively from the memory 622, spaced with four data elements in between, or a stride of four). Further, the second segmented-strided vector instruction may complete the load of the vector register 815 with fewer memory accesses than had constant-stride memory accesses been used.

To complete the transposition of the matrix 810, one or more unit-stride memory accesses (e.g., one or more unit-stride store vector instructions) may execute to store data elements, from the vector register 815, consecutively in linear locations in the memory 812. For example, a first unit-stride memory access may store data elements A, B, C, and D, from a first group of four consecutive locations in the vector register 815, to a first group of four consecutive locations in the memory 822. A second unit-stride memory access may store data elements E, F, G, and H, from a second group of four consecutive locations in the vector register 815, to a second group of four consecutive locations in the memory 822 (e.g., adjacent to the first group of four consecutive locations in the memory 822). A third unit-stride memory access may store data elements I, J, K, and L, from the third group of four consecutive locations in the vector register 815, to a third group of four consecutive locations in the memory 822 (e.g., adjacent to the second group of four consecutive locations in the memory 822). A fourth unit-stride memory access may store data elements M, N, O, and P, from a fourth group of four consecutive locations in the vector register 815, to a fourth group of four consecutive locations in the memory 822 (e.g., adjacent to the third group of four consecutive locations in in the memory 822). The unit-stride memory accesses may complete the transposition of the matrix 810 to generate the matrix 820.

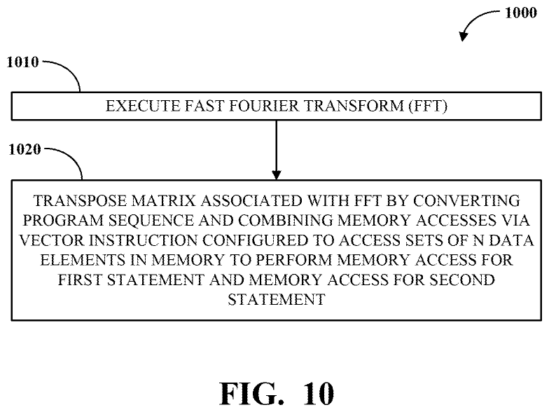

FIG. 10 is a flow chart of an example of a process 1000 for executing an FFT computation. For example, the process 1000 may be implemented using the integrated circuit 110 of FIG. 1 or the integrated circuit 210 of FIG. 2. The process 1000 may include executing 1010 an FFT. For example, the FFT may be a Cooley-Tukey, Pease, or Stockham FFT. The process 1000 may also include transposing 1020 a matrix when executing the FFT. The matrix may be transposed by converting a program sequence, comprising an inner loop nested in an outer loop, to multiple statements of the inner loop, and combining memory accesses for statements of the inner loop (e.g., a first statement and a second statement) via a vector instruction (e.g., a stride segment fusion, such as via a segmented-strided vector instruction). The vector instruction may be configured to access sets of N data elements in memory to perform a memory access for the first statement and a memory access for the second statement. For example, one or more steps of the process 500 of FIG. 5 may be used for transposing the matrix.

The process 1000 can be used to implement more efficient FFT computations. For example, the process 1000 can reduce the cost of strided accesses in Stockham's algorithm with middle-loop vectorization. Stockham's FFT algorithm with inner-loop vectorization features all unit-stride accesses, but suffers shorter application vectors as the computation proceeds. Swarztrauber's variant switches, at an intermediate stage, to middle-loop vectorization to maintain high vector utilization, but sacrifices the unit-stride access pattern subsequently: process 1000 can be applied here. In some implementations, the process 1000 can be applied to a hybrid Stockham-Swarztrauber FFT, where, when switching from inner-loop to middle-loop vectorization, simultaneous transposition of the data array and switching to the “transpose Stockham” algorithm occurs. The transposition is fused into the adjacent stages, so that there is only a single strided load (or store) of the data array. Stride segment fusion (e.g., via a segmented-strided vector instruction) can then be applied to that stage. The process 1000 can be used to optimize any of the well-known FFT factorizations such as Cooley-Tukey, Pease, transposed Stockham, and others. In some implementations, Bailey's long weight vector optimization can also be applied to ensure twiddle-factor loads are purely unit-stride.

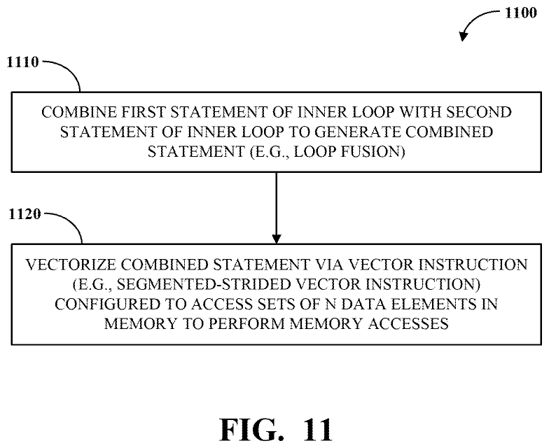

FIG. 11 is a flow chart of an example of a process 1100 for combining statements of an inner loop to generate a combined statement and vectorizing the combined statement. For example, the process 1100 may be implemented using the integrated circuit 110 of FIG. 1 or the integrated circuit 210 of FIG. 2. The process 1100 may include combining 1110 a first statement of an inner loop with a second statement of the inner loop to generate a combined statement (e.g., loop fusion or jamming). The process 1100 may also include vectorizing 1120 the combined statement via a vector instruction (e.g., a stride segment fusion, such as via a segmented-strided vector instruction). The vector instruction may be configured to access sets of N data elements in memory to perform a memory access for the first statement and a memory access for the second statement. For example, the combining 1110 and the vectorizing 1120 may be implemented when implementing one or more steps of the process 500 of FIG. 5, such as the converting 520.

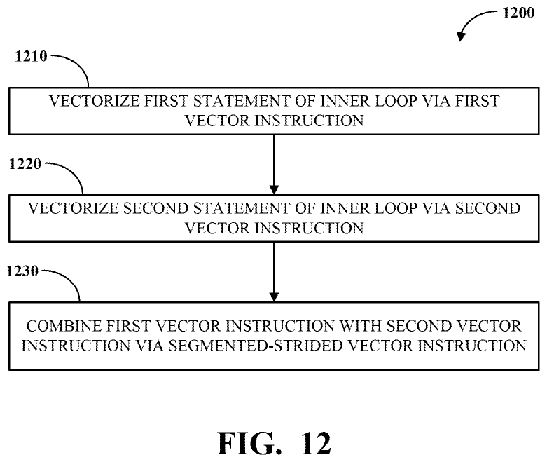

FIG. 12 is a flow chart of an example of a process 1200 for vectorizing statements of an inner loop to generate vector instructions and combining the vector instructions. For example, the process 1200 may be implemented using the integrated circuit 110 of FIG. 1 or the integrated circuit 210 of FIG. 2. The process 1200 may include vectorizing 1210 a first statement of an inner loop via a first vector instruction. The first vector instruction may be a first constant-stride vector instruction. The process 1200 may also include vectorizing 1220 a second statement of an inner loop via a second vector instruction. The second vector instruction may be a second constant-stride vector instruction. The process 1230 may also include combining 1230 the first vector instruction with the second vector instruction via a third vector instruction (e.g., a stride segment fusion, such as via a segmented-strided vector instruction). For example, the vectorizing 1210, the vectorizing 1220, and the combining 1230 may be implemented when implementing one or more steps of the process 500 of FIG. 5, such as the converting 520.

Some implementations may include a method comprising: converting a program sequence, the program sequence comprising an inner loop nested in an outer loop, to multiple statements of the inner loop with a statement of the multiple statements changing according to an index of the outer loop; and combining a memory access for a first statement of the multiple statements with a memory access for a second statement of the multiple statements using a vector instruction, wherein the vector instruction accesses sets of N data elements, where N is a segment size of data elements in consecutive locations in memory, and where sets of N data elements are spaced at a constant distance in memory. In some implementations, the vector instruction is a segmented-strided vector instruction, and the segmented-strided vector instruction combines a constant-stride memory access for the first statement with a constant-stride memory access for the second statement. In some implementations, the method may include producing compiled code implementing the vector instruction, wherein the compiled code is configured to transpose data elements in memory from a first ordered arrangement associated with a first matrix to a second ordered arrangement associated with a second matrix. In some implementations, the vector instruction does at least one of: store the sets of N data elements from a vector register to locations in memory: or load the sets of N data elements from locations in memory to a vector register. In some implementations, the method may include producing compiled code implementing the vector instruction, wherein the compiled code is configured to execute a FFT computation. In some implementations, the method may include producing compiled code implementing the vector instruction, wherein the compiled code is configured to transpose data elements associated with a matrix for a Stockham FFT computation. In some implementations, the method may include producing compiled code implementing the vector instruction, wherein the compiled code is configured to execute a matrix-multiplication operation. In some implementations, the method may include executing a compiler to translate the program sequence to object code, wherein the compiler combines a constant-stride memory access for the first statement with a constant-stride memory access for the second statement to implement the vector instruction. In some implementations, the combining includes: combining the first statement with the second statement to generate a combined statement; and vectorizing the combined statement via the vector instruction. In some implementations, the vector instruction is a segmented-strided vector instruction, and the combining includes: vectorizing the first statement via a first vector instruction: vectorizing the second statement via a second vector instruction; and combining the first vector instruction with the second vector instruction via the segmented-strided vector instruction.

Some implementations may include a method comprising: unrolling a program sequence to generate multiple statements of an inner loop, wherein a statement of the multiple statements changes by an index of an outer loop; and combining a memory access for a first statement of the multiple statements with a memory access for a second statement of the multiple statements via a vector instruction, wherein the vector instruction accesses sets of N data elements, where N is a segment size of data elements in consecutive locations in memory, and where sets of N data elements are spaced at a constant distance in memory. In some implementations, the method may include producing compiled code implementing the vector instruction, wherein the compiled code is configured to transpose data elements in memory from a first ordered arrangement associated with a first matrix to a second ordered arrangement associated with a second matrix. In some implementations, the method may include producing compiled code implementing the vector instruction, wherein the compiled code is configured to execute an FFT computation. In some implementations, the method may include producing compiled code implementing the vector instruction, wherein the compiled code is configured to transpose data elements associated with a matrix for a Stockham FFT computation. In some implementations, the method may include producing compiled code implementing the vector instruction, wherein the compiled code is configured to execute a matrix-multiplication operation.

Some implementations may include an apparatus comprising: a processor core configured to: convert a program sequence, comprising an inner loop nested in an outer loop, to multiple statements of the inner loop with a statement of the multiple statements changing by an index of the outer loop; and combine a memory access for a first statement of the multiple statements with a memory access for a second statement of the multiple statements via a vector instruction, wherein the vector instruction accesses sets of N data elements, where N is a segment size of data elements in consecutive locations in memory, and where sets of N data elements are spaced at a constant distance in memory. In some implementations, the processor core is configured to: produce compiled code implementing the vector instruction, wherein the compiled code is configured to transpose data elements in memory from a first ordered arrangement associated with a first matrix to a second ordered arrangement associated with a second matrix. In some implementations, the processor core is configured to: produce compiled code implementing the vector instruction, wherein the compiled code is configured to execute an FFT computation. In some implementations, the processor core is configured to: produce compiled code implementing the vector instruction, wherein the compiled code is configured to transpose data elements associated with a matrix for a Stockham FFT computation. In some implementations, the processor core is configured to: produce compiled code implementing the vector instruction, wherein the compiled code is configured to execute a matrix-multiplication operation.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A method comprising:
converting a program sequence, the program sequence comprising an inner loop nested in an outer loop, to multiple statements of the inner loop with a statement of the multiple statements changing according to an index of the outer loop; and
combining a memory access for a first statement of the multiple statements with a memory access for a second statement of the multiple statements using a vector instruction, wherein the vector instruction accesses sets of N data elements, where N is a segment size of data elements in consecutive locations in memory, and where sets of N data elements are spaced at a constant distance in memory.

2. The method of claim 1, wherein the vector instruction is a segmented-strided vector instruction, and wherein the segmented-strided vector instruction combines a constant-stride memory access for the first statement with a constant-stride memory access for the second statement.

3. The method of claim 1, further comprising:
producing compiled code implementing the vector instruction, wherein the compiled code is configured to transpose data elements in memory from a first ordered arrangement associated with a first matrix to a second ordered arrangement associated with a second matrix.

4. The method of claim 1, wherein the vector instruction does at least one of:
store the sets of N data elements from a vector register to locations in memory: or
load the sets of N data elements from locations in memory to a vector register.

5. The method of claim 1, further comprising:
producing compiled code implementing the vector instruction, wherein the compiled code is configured to execute a fast Fourier transform (FFT) computation.

6. The method of claim 1, further comprising:
producing compiled code implementing the vector instruction, wherein the compiled code is configured to transpose data elements associated with a matrix for a Stockham FFT computation.

7. The method of claim 1, further comprising:
producing compiled code implementing the vector instruction, wherein the compiled code is configured to execute a matrix-multiplication operation.

8. The method of claim 1, further comprising:
executing a compiler to translate the program sequence to object code, wherein the compiler combines a constant-stride memory access for the first statement with a constant-stride memory access for the second statement to implement the vector instruction.

9. The method of claim 1, wherein the combining includes:
combining the first statement with the second statement to generate a combined statement; and
vectorizing the combined statement via the vector instruction.

10. The method of claim 1, wherein the vector instruction is a segmented-strided vector instruction, and wherein the combining includes:
vectorizing the first statement via a first vector instruction;
vectorizing the second statement via a second vector instruction; and
combining the first vector instruction with the second vector instruction via the segmented-strided vector instruction.

11. A method comprising:
unrolling a program sequence to generate multiple statements of an inner loop, wherein a statement of the multiple statements changes by an index of an outer loop; and
combining a memory access for a first statement of the multiple statements with a memory access for a second statement of the multiple statements via a vector instruction, wherein the vector instruction accesses sets of N data elements, where N is a segment size of data elements in consecutive locations in memory, and where sets of N data elements are spaced at a constant distance in memory.

12. The method of claim 11, further comprising:
producing compiled code implementing the vector instruction, wherein the compiled code is configured to transpose data elements in memory from a first ordered arrangement associated with a first matrix to a second ordered arrangement associated with a second matrix.

13. The method of claim 11, further comprising:
producing compiled code implementing the vector instruction, wherein the compiled code is configured to execute an FFT computation.

14. The method of claim 11, further comprising:
producing compiled code implementing the vector instruction, wherein the compiled code is configured to transpose data elements associated with a matrix for a Stockham FFT computation.

15. The method of claim 11, further comprising:
producing compiled code implementing the vector instruction, wherein the compiled code is configured to execute a matrix-multiplication operation.

16. An apparatus comprising:
a processor core configured to:
convert a program sequence, comprising an inner loop nested in an outer loop, to multiple statements of the inner loop with a statement of the multiple statements changing by an index of the outer loop; and
combine a memory access for a first statement of the multiple statements with a memory access for a second statement of the multiple statements via a vector instruction, wherein the vector instruction accesses sets of N data elements, where N is a segment size of data elements in consecutive locations in memory, and where sets of N data elements are spaced at a constant distance in memory.

17. The apparatus of claim 16, wherein the processor core is configured to:
produce compiled code implementing the vector instruction, wherein the compiled code is configured to transpose data elements in memory from a first ordered arrangement associated with a first matrix to a second ordered arrangement associated with a second matrix.

18. The apparatus of claim 16, wherein the processor core is configured to:
produce compiled code implementing the vector instruction, wherein the compiled code is configured to execute an FFT computation.

19. The apparatus of claim 16, wherein the processor core is configured to:
produce compiled code implementing the vector instruction, wherein the compiled code is configured to transpose data elements associated with a matrix for a Stockham FFT computation.

20. The apparatus of claim 16, wherein the processor core is configured to:
produce compiled code implementing the vector instruction, wherein the compiled code is configured to execute a matrix-multiplication operation.
